(19) United States
(12) Patent Application Publication
(10) Pub. No.: US 2003/0126141 A1
(43) Pub. Date: Jul. 3, 2003

(54) System and method for managing and resourcing persons, skill sets and project requirements

(75) Inventors: Edward Hassman, Parker, CO (US); Mariamne L. Livingston, Denver, CO (US); Timothy Allen Lee, Loveland, CO (US); Edward M. Miller, Centennial, CO (US)

Correspondence Address: SPRINT COMMUNICATIONS COMPANY L.P., 6391 SPRINT PARKWAY, KSOPHT0101-Z2100, OVERLAND PARK, KS, 66251-2100, US

(73) Assignee: Sprint Communications Company, L.P.

(21) Appl. No.: 10/034,182

(22) Filed: Dec. 28, 2001

(51) Int. Cl. G06F 7/00

(52) U.S. Cl. 707/100

(57) ABSTRACT

A method of managing and resourcing persons, skill sets and project requirements is provided. The method includes means for defining resources and project requirements, examining both the resources and project requirements and matching the available resources to the projects as appropriate. The method also provides for increased visibility among the persons involved in the identification, staffing and completion of professional services and/or consulting projects.

### STATEMENT REGARDING FEDERALLY SPONSORED RESEARCH OR DEVELOPMENT

Not Applicable.

### CROSS-REFERENCE TO RELATED APPLICATIONS

Not Applicable.

### BACKGROUND OF THE INVENTION

The present invention relates generally to computer software. More particularly, the present invention relates to a system and method for organizing projects and project resources in a computer system.

Generally, a minimum of four persons are involved in the acquisition, staffing and completion of a typical professional services or consulting project. First, a sales person identifies a project in need of completion and bids on the work. Second, a project manager manages the staffing and time-line based completion of the project, once acquired, to ensure the work is done efficiently and in a timely fashion. Thirdly, a technical personnel manager acquires and maintains the persons necessary to complete the project. Lastly, a technical consultant performs the work associated with the acquired project.

With so many different persons involved, it is not difficult to see that there are multiple opportunities for communication break-downs that potentially could result in a loss of opportunity and revenue for the organization. For instance, a significant problem in the professional services industry today is that sales persons are forced to accept projects based upon a perceived availability of technical personnel to complete them. Often times sales persons do not have access to information regarding the number of persons to whom the organization has access who possess the appropriate skills for a project that has been identified. Accordingly, the sales person may turn down a project the organization could have taken on because he/she did not realize the organization had the staff available to complete the work. Alternatively, the sales person may accept a project only later to discover that the organization does not have access to consultants possessing the necessary skills for completion; either because the organization does not employ or contract with anyone possessing those skills, or because the persons who possess the appropriate skills are tied up on another project until such time as would make the timely completion of the project impossible.

Further, it is not unusual in the arena of professional services for organizations to have difficulty in acquiring and retaining a sufficient number of technical personnel possessing the appropriate skills and skill levels to perform the tasks that clients desire to have done. A technical personnel manager may not be aware that one of the consultants already on staff and available to work possesses a skill other than that for which he/she was hired and, thus, expend time and resources attempting to hire another consultant with the necessary skills. Alternatively, a technical personnel manager or a project manager for a newly acquired project may commit a particular consultant to a project without being aware that the consultant is already committed to another project and is not available for the newly acquired project due to limited access to scheduling information.

In another instance, upon completion of a current project, a technical consultant may be unaware of what other work is available that he/she may be qualified to perform. This could result in the consultant being “perched” for a period of time and not working despite a need for a consultant with his/her technical qualifications.

Any one of the above scenarios, or a combination of them, results in a loss of opportunity and revenue for the organization. These difficulties exist not due to a lack of qualified professional services consultants or a lack of consulting projects in need of staffing and completion. Rather, the difficulties largely are due to insufficient means of communication among the various persons involved in identifying, staffing and completing such consulting projects. As such, a system and method is needed for improving the communication between the parties involved in staffing and completing a professional services or consulting project such that scenarios such as those mentioned above are minimized.

There is no known program which manages persons, skills and skill sets, and current and projected projects, which is capable of cross-referencing among these areas to make all relevant information known to all persons involved at a time when it is critical to them to have the information. Accordingly, a system and method which allows for the integration, resourcing and aligning of persons, skill sets and project demands would be advantageous to those in the professional services arena.

### SUMMARY OF THE INVENTION

Generally described, a method and system of managing and resourcing persons, skill sets and project requirements is provided. The method includes means for defining resources and project requirements, examining both the resources and project requirements and matching the available resources to the projects as appropriate. The method also provides for increased visibility among the persons involved in the identification, staffing and completion of professional services and/or consulting projects.

Additional aspects of the invention, together with the advantages and novel features appurtenant thereto, will be set forth in part in the description which follows, and in part will become apparent to those skilled in the art upon examination of the following, or may be learned from the practice of the invention. The aspects and advantages of the invention may be realized and attained by means, instrumentalities and combinations particularly pointed out in the appended claims.

### BRIEF DESCRIPTION OF THE SEVERAL VIEWS OF THE DRAWINGS

In the accompanying drawings which form a part of the specification and are to be read in conjunction therewith, and in which like reference numerals are employed to indicate like parts in the various figures:

FIG. 1 is a block diagram of a computing system environment suitable for use in implementing the present invention;

FIG. 2 is a more detailed block diagram of a computing system suitable for use in implementing the present invention;

FIG. 3 is a more detailed block diagram of a wireless system suitable for use in implementing the present invention;

FIG. 4 is a block diagram illustrating the overall integration effected by the inventive system of the present invention;

FIG. 5 is a schematic view illustrating the flow of the present inventive system;

FIG. 6 is a schematic view of a preferred means of carrying out the resource definition step of FIG. 5;

FIG. 7 is a schematic view of a preferred means of carrying out the project and requirement identification step of FIG. 5;

FIG. 8 is a schematic view of a preferred means of carrying out the resource availability examination step of FIG. 5;

FIG. 9 is a schematic view of a preferred means of carrying out the preliminary matching step of FIG. 5;

FIG. 10 is a schematic view of a preferred means of carrying out the match confirmation or modification step of FIG. 5; and

FIG. 11 is a schematic view of the tables that may define a preferred system according to the present invention.

### DETAILED DESCRIPTION OF THE INVENTION

The present invention is directed to a system and method for integrating, resourcing and aligning the persons, skill sets and project demands associated with service organizations. The particular embodiments described herein are intended in all respects to be illustrative rather than restrictive. Alternative embodiments will become apparent to those skilled in the art to which the present invention pertains without departing from its scope.

### Exemplary Operating Environment

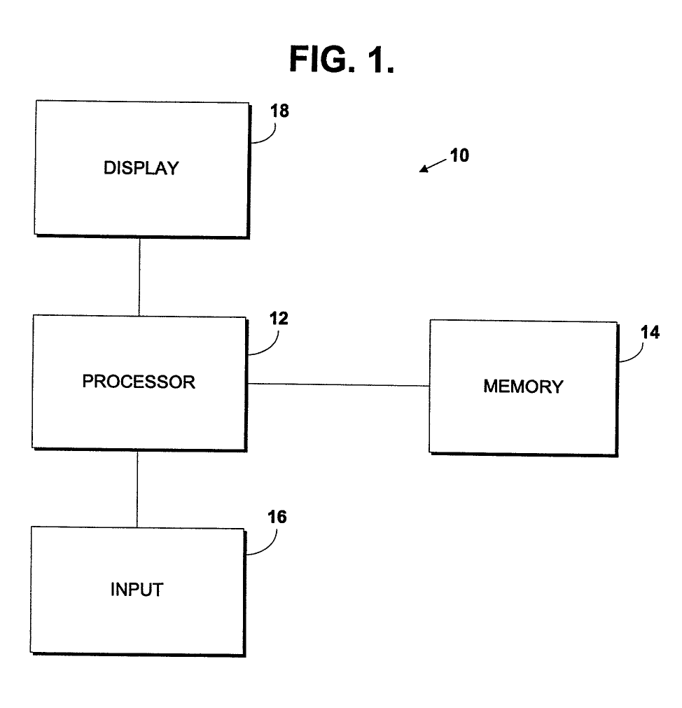

Referring to the drawings in general and initially to FIG. 1 in particular, wherein like reference numerals identify like components in the various figures, an exemplary operating environment for implementing the present invention is shown and designated generally as operating environment 10. In its most basic configuration, operating environment 10 typically includes a processor 12 and a memory 14. Depending upon the exact configuration and type of operating environment, memory 14 may be volatile (e.g., random access memory (RAM)), non-volatile (e.g., read only memory (ROM), flash memory, etc.) or some combination of volatile and non-volatile memory. Additionally, operating environment 10 also may have mass storage (removable and/or nonremovable) such as magnetic tape, magnetic disks, and/or optical disks. The operating environment 10 further typically includes an operating system which is resident on the memory 14 and executes on the processor 12.

Operating environment 10 also may include an input 16 and/or an output, such as a display 18. Merely by way of illustration and not restriction, input 16 may be any one of a variety of inputs known in the art, or any combination thereof, such as a keypad, mouse, pen, voice input device, touch input device, and the like. Similarly, output 18 may be any one or a combination of a variety of outputs known in the art such as a display, speakers, printer, and the like. All such devices are well known in the art and need not be discussed at length herein. It will be understood and appreciated that various inputs or outputs may be utilized with the operating environment of the present invention and such variations are contemplated to be within the scope hereof.

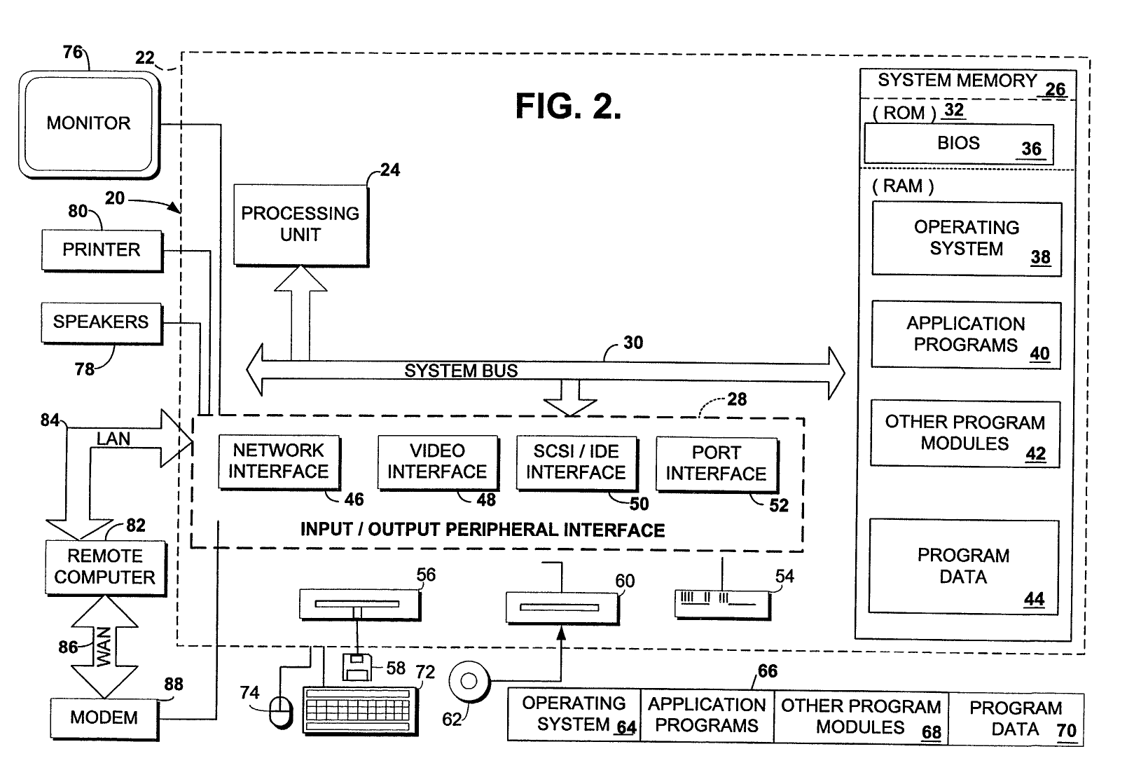

In greater detail, FIG. 2 illustrates an example of a suitable operating environment 20 on which the present invention may be implemented. Operating environment 20 is a computing system environment and is merely one example of a suitable operating environment. Computing system environment 20 is not intended to suggest any limitation as to the scope of use or functionality of the present invention. Further, computing system environment 20 should not be interpreted as having any dependency or requirement relating to any one of the components, or any combination thereof, illustrated in the exemplary computing environment 20.

The present invention may be described in the general context of computer-executable instructions, such as program modules, being executed by a computer. Generally, program modules include routines, programs, objects, components, data structures, and the like, that perform particular tasks or implement particular abstract data types. Moreover, those skilled in the art will appreciate that the present invention is operational with a variety of additional general purpose or special purpose computing systems, environments, and/or configurations. Examples of well known computing systems, environments, and/or configurations that may be suitable for use with the present invention include, but are not limited to, personal computers, server computers, hand-held or laptop devices, multiprocessor systems, microprocessor-based systems, programmable consumer electronics, network PCs, minicomputers, mainframe computers, and the like. The invention also may be practiced in distributed computing environments wherein tasks are performed by remote processing devices that are linked through a communications network. In a distributed computing environment, program modules may be located in both local and remote computer storage media including memory storage devices.

With reference to FIG. 2, an exemplary system for implementing the present invention includes a general purpose computing device in the form of a computer 22. Components of computer 22 include, but are not limited to, a central processing unit (CPU) 24, a system memory 26, an input/output (I/O) Interface 28, and a system bus 30 that couples various system components with one another, including coupling the system memory with the processing unit. The system bus 30 may be any of several types of bus structures including a memory bus or memory controller, a peripheral bus, and a local bus using any of a variety of bus architectures. By way of example, and not restriction, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

Computer 22 typically includes a variety of computer readable media. By way of example, and not restriction, computer readable media may comprise computer storage media and communication media. Computer storage media includes both volatile and nonvolatile storage media, and removable and non-removable storage media, each implemented in any method or technology for storage of information such as computer readable instructions, data structures, program modules or other data. Examples of computer storage media include, but are not limited to, RAM, ROM, electronically erasable programmable read-only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 22.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not restriction, communication media includes wired media such as a wired network or direct wired connection, and wireless media such as acoustic, RF, infrared and other wireless media. It will be understood and appreciated that combinations of any of the above also are included within the scope of computer readable media.

The system memory 26 includes computer storage media in the form of volatile and/or nonvolatile memory such as ROM 32 (nonvolatile) and RAM 34 (volatile). A basic input/output system (BIOS) 36, containing the basic routines that help to transfer information between elements within computer 22, such as during start-up, is typically stored in ROM 32. RAM 34 typically contains data and/or program modules that are presently being operated on by processing unit 24, and/or are immediately accessible to the processing unit. By way of example, and not restriction, FIG. 2 illustrates operating system 38, application programs 40, other program modules 42, and program data 44 as data and/or program modules stored in RAM 34.

The I/O Interface 28 includes a variety of components that provide physical connections and communications between peripheral devices and the processing unit 24, system bus 30 and system memory 26 of computer 22. By way of example only, I/O Interface 28 may include network interface 46, video interface 48, Small Computer System Interface (SCSI) or Integrated Device Electronics (IDE) Interface 50, or other mass storage-type interface, and serial, parallel, USB, or other bus-type port interface 52. As would be understood and appreciated by those of skill in the art, I/O Interface 28 may include interface components that are integrated, provided as an add-on hardware device, provided as a software component or a combination of software and hardware. All such variations are contemplated to be within the scope hereof.

The computer 22 also may include other computer storage media which may be removable and/or nonremovable, volatile and/or nonvolatile. By way of example only, FIG. 2 illustrates other computer storage media as a hard disk drive 54, a magnetic disk drive 56 and an optical disk drive 60. Hard disk drive 54 reads from and/or writes to nonremovable, nonvolatile magnetic media. Magnetic disk drive 56 reads from and/or writes to a removable, nonvolatile magnetic disk 58. Optical disk drive 60 reads from or writes to a removable, nonvolatile optical disk 62 such as a CD ROM, DVD or other optical media. By way of example, and not restriction, other removable/nonremovable, volatile/nonvolatile computer storage media that can be used in the exemplary operating environment include magnetic tape cassettes, flash memory cards, digital video tape, Bernoulli cartridges, solid state RAM, solid state ROM, and the like. Computer storage media typically is connected to the system bus 30 through I/O Interface 28. Various types of I/O interfaces may be used in the exemplary operating environment 20 and are known to those of skill in the art. For instance, the hard disk drive 54, magnetic disk drive 56, and optical disk drive 60 may be connected to the system bus 30 by a SCSI or IDE Interface 50. It will be understood and appreciated that the above interfaces are merely examples of interfaces that may be suitable for the exemplary computing system 20 and should not be viewed as limitations of the present invention.

The drives and their associated computer storage media discussed above and illustrated in FIG. 2, provide storage of computer readable instructions, data structures, program modules and other data for the computer 22. In FIG. 2, for example, hard disk drive 54 is illustrated as storing operating system 64, application programs 66, other program modules 68, and program data 70. Note that these components either can be the same as or different from operating system 38, application programs 40, other program modules 42, and program data 44. Typically, the operating system, application programs and the like that are stored in RAM are portions of the corresponding systems, programs, or data read from hard disk drive 54, the portions varying in size and scope depending on the functions desired. Operating system 64, application programs 66, other program modules 68, and program data 70 are given different numbers herein to illustrate that, at a minimum, they are different copies.

A user may enter commands and information into the computer 22 through input devices such as a keyboard 72 and pointing device 74, commonly referred to as a mouse, trackball or touch pad. Other input devices (not shown) may include a microphone, joystick, game pad, satellite dish, scanner, or the like. These and other input devices often are connected to the processing unit 24, generally through I/O Interface 28 that is coupled to the system bus 30, more particularly through port interface 52. As previously discussed, input devices may be connected by interface components and bus structures, such as a parallel port, game port or a universal serial bus (USB) port. A monitor 76 or other type of display device also is connected to system bus 30 via an interface such as I/O Interface 28. In addition to the monitor, computers also may include other peripheral output devices such as speakers 78 and printer 80, which also may be connected through I/O interface 28. By way of example only, a typical I/O interface for an output peripheral device such as monitor 76 is a video interface 48.

The computer 22 in the present invention is capable of operating in a networked environment using logical connections to one or more remote computers, such as remote computer 82. The remote computer 82 may be a personal computer, a server, a router, a network PC, a peer device or other common network node, and typically includes many or all of the elements described above relative to the computer 22. The logical connections depicted in FIG. 2 include a local area network (LAN) 84 and a wide area network (WAN) 86, but may also include other networks. Such networking environments are commonplace in offices, enterprise-wide computer networks, intranets and the Internet.

When used in a LAN networking environment, the computer 22 is connected to the LAN 84 through a network interface 46 or adapter card. When used in a WAN networking environment, the computer 22 typically includes a modem 88 or other means for establishing communications to the WAN 86, such as the Internet. The modem 88, which may be internal or external, may be connected to the system bus 30 via the I/O Interface 28, or other appropriate mechanism. It will be understood and appreciated by those of skill in the art that the network connections shown are exemplary and other means of establishing a communications link between the computers may be used.

Although many other internal components of the computer 22 are not shown, those of ordinary skill in the art will appreciate that such components and the interconnection are well known. Accordingly, additional details concerning the internal construction of the computer 22 need not be disclosed in connection with the present invention.

When the computer 22 is turned on or reset, the BIOS 36, which is stored in the ROM 32 instructs the processing unit 24 to load the operating system, or necessary portion thereof, from the hard disk drive 54 into the RAM 34. Once the copied portion of the operating system, designated as operating system 38, is loaded in RAM 34, the processing unit 24 executes the operating system code and causes the visual elements associated with the user interface of the operating system 38 to be displayed on the monitor 76. Typically, when an application program 66 is opened by a user, the program code and relevant data are read from the hard disk drive 54 and the necessary portions are copied into RAM 34, the copied portion represented herein by reference numeral 40.

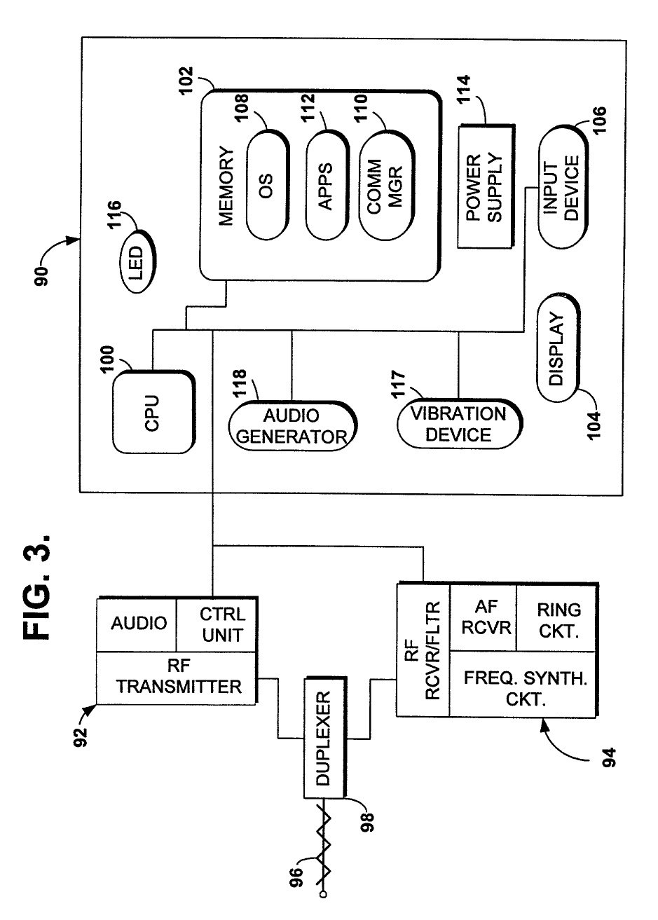

FIG. 3 illustrates an alternative suitable computing environment 90 on which the invention may be implemented. Alternative computing environment 90 is a wireless environment and is merely a second example of a suitable computing environment and is not intended to suggest any limitation as to the scope of use or functionality of the invention. Neither should alternative computing environment 90 be interpreted as having any dependency or requirement relating to any one or combination of components illustrated in the exemplary environment 90.

Wireless environment 90 includes transmission circuitry 92 and receiving circuitry 94 that jointly utilize an antenna 96 through a duplexer 98. Wireless environment 90 further includes several components that are similar to computing environment 20. For instance, similar to computing environment 20, wireless environment 90 generally includes a processor 100, a memory 102, a display 104 and an input 106. The memory 102 may be volatile (e.g., RAM), non-volatile (e.g., ROM, Personal Computer Memory Card International Association (PCMCIA) cards), or some combination of volatile and non-volatile memory. Like computing environment 20, wireless environment 90 typically includes a variety of computer readable media. Examples include, but are not limited to, Programmable Read-Only Memory (PROM) and Erasable Programmable Read-Only Memory (EPROM). The wireless environment 90 further typically includes an operating system 108 which is resident on the memory 102 and executes on the processor 100.

Memory 102 also includes one or more application programs that interact with the operating system 108. Examples of applications include, but are not limited to, email programs, scheduling programs, PIM (personal information management) programs, word processing programs, spreadsheet programs, Internet browser programs and the like. Wireless environment 90 also includes a notification manager 110 loaded in memory 102. The notification manager handles notification requests from application programs 112 and other operating system functions.

Wireless environment 90 further includes a power supply 114 which may be implemented as one or more batteries, such as nickel-cadmium (NiCAD) batteries. The power supply 114 may further include an external power source (not shown) that overrides or recharges the built-in batteries, such as an AC adapter or a powered docking cradle.

Wireless environment 90 is illustrated with three types of external notification mechanisms: an LED 116 or other display, a vibration device 117 and an audio generator 118. These devices are directly coupled to the power supply 114 so that, when activated, they remain on for a duration dictated by the notification mechanism even though the processor 100 and/or other components might be shut down to conserve battery power. The display 104 preferably remains on indefinitely unless and until the user takes action. The vibration device 117 and audio generator 118 may be configured to conserve power by turning off when the rest of the system is off, or at some finite duration after activation.

Within a typical wireless environment 90, radio RF transmitter 92 and radio receiver 94 sections couple transmit and receive functions through a duplexer 98 and an antenna 96. In operation, the processor 100 receives program instructions from memory 102. The wireless environment 90 must receive and transmit a ream of data back and forth to a communications cell site. Signal (e.g., voice/data) is received from a cell site and is filtered and processed to be heard in a speaker. The processor 100 sends data to and from a frequency synthesizer which, after processing this data, sets up the correct transmit and receiver frequencies. The frequency synthesizer within the receiver 94, with instructions from the processor 100 tunes the wireless environment 90 to the proper receive and transmit channels.

Also within a wireless environment 90 is an input device 106 which may include a microphone, a touch screen display, keyboard or other mechanism for accepting information from a user, or from another external device. Regardless of the source of incoming information that needs to be transmitted, a control unit within the transmitter 92 receives a signal and relevant data from processor 100. The control unit formulates and prepares the data for transmission, using an RF transmitter, the duplexer 98 and the antenna 96. The duplexer 98 operates as a switch allowing alternate connections to the antenna 96 by the receiving circuitry 94 and the transmitting circuitry 92. On the receiving side, incoming signals are received, filtered and then processed by the receiver circuitry. The receiver circuitry in conjunction with the processor 100 then may cause information in the form of signals or data to be sent to the audio generator 118, the display 104, or other components of the wireless environment 90.

It should be noted that the RF carrier with modulation that is transmitted back and forth in wireless environment 90, also can be modulated with speech data or other control signals.

### System and Method for Managing Project Resources

The present invention is directed to a system and method for integrating, resourcing and aligning the technical personnel, skill sets and project demands associated with service organizations. The method and system of the present invention are table-driven and may be utilized in a wireless and/or web-enabled environment. The personnel and project management system of the present invention involves the creation of desired tables, population of those tables and facilitated retrieval of information therefrom.

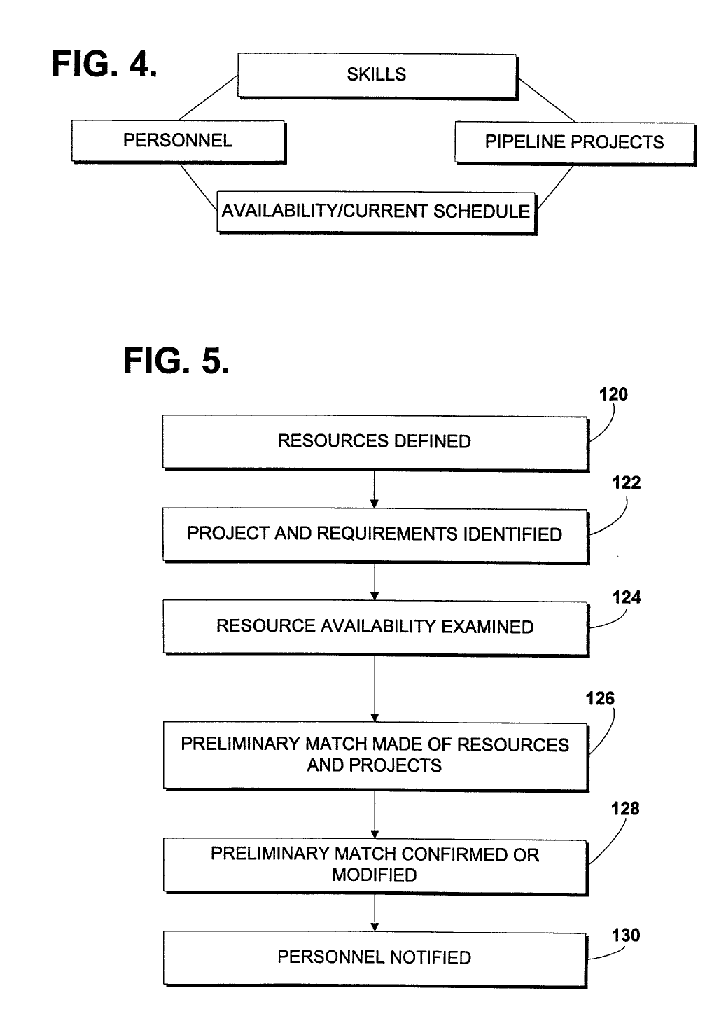

A preferred embodiment of the present invention includes many features which are not found in conventional project management products, including the ability to simultaneously manage projects, project resources and personnel. FIG. 4 illustrates a general overview of the invention. Visibility and flow of information is enhanced through providing simultaneous access to personnel, skills, availability (current schedules and commitments) and pipeline projects, i.e., those for which work has not yet begun. Pipeline projects either already may be assigned to the appropriate personnel or may be awaiting such assignment. This simultaneous visibility and access provides improved ability to maximize available resources as well as to identify weaknesses in available resources. These weaknesses then may be remedied prior to becoming a debilitating impediment to the organization's revenue.

With reference to FIG. 5, a more in-depth overview of a preferred embodiment of the present invention is illustrated. The present invention provides a system and method wherein resources are defined, as illustrated at step 120, and projects and their associated requirements are identified, as illustrated at step 122. Once a particular project and its requirements have been identified, the defined resources are examined at step 124 to determine whether the project may be staffed with the resources available. If it is determined that the project can be staffed with available resources, a preliminary matching of resources and projects is made, as illustrated at step 126. Before a project is signed and/or before technical personnel are committed to a project, the preliminary match either must be confirmed or modified at step 128. Once a project-personnel matching has been confirmed, all appropriate persons are notified, as illustrated at step 130, via email or other conventional means known in the relevant art. Each of these general functions is examined in more detail below.

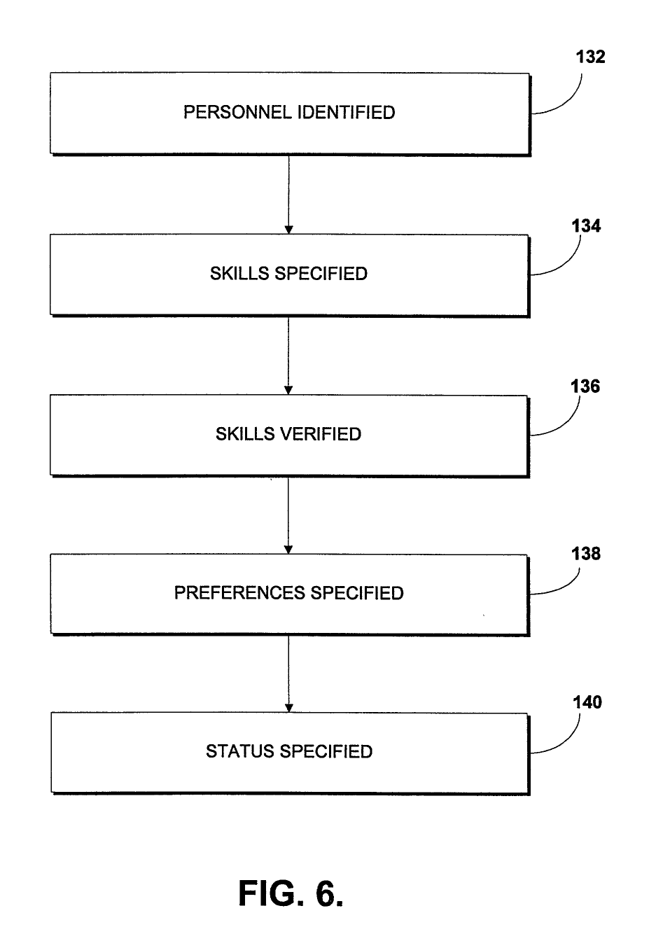

Referring now to FIG. 6, a preferred method for defining resources is illustrated. It will be understood and appreciated that the defining steps are merely exemplary and do not limit the scope of the present invention. In general, “resources,” as that term is used herein, refers to those personnel either employed by the organization utilizing the present invention, or personnel who have contracts to perform work for the organization, e.g., consultants. The terms “employee,” “contractor,” and “consultant” are used interchangeably herein and each is intended to encompass personnel whose status falls within any of these technical categories. “Resources” further includes the skills possessed by all personnel as well as their level of proficiency at those skills. There are many potential methods of identifying skills and proficiency, a few of which are discussed in further detail below. The delineated methods, however, are merely exemplary and not intended to limit the scope of the present invention. The term “resources” also may include such items as personnel availability and preferences as desired.

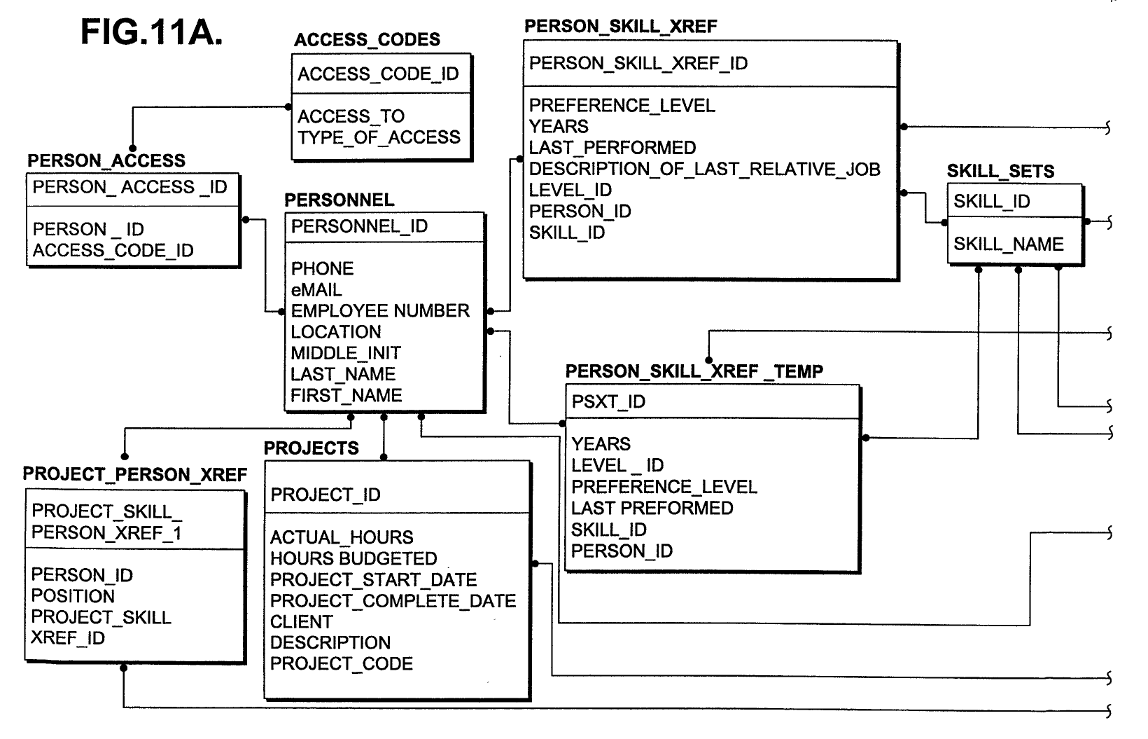

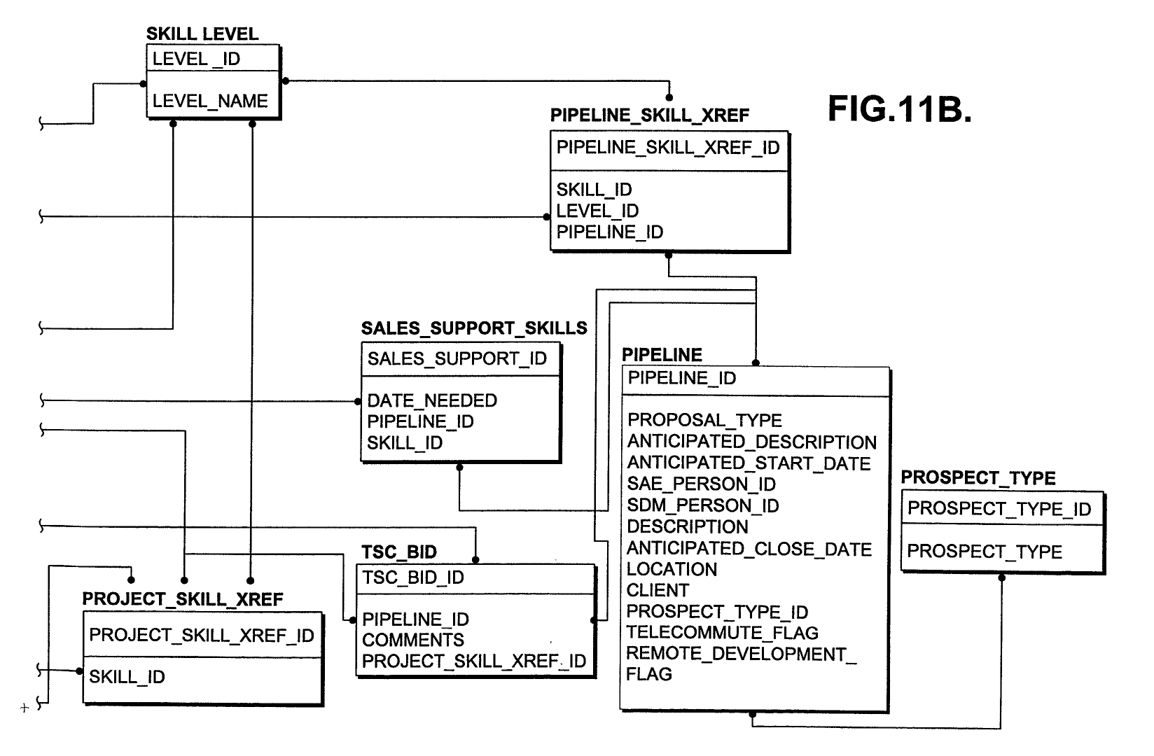

In a preferred embodiment of the invention, resources are defined by identifying personnel, as illustrated at step 132, specifying the skills possessed by the identified personnel at step 134, and verifying those skills at step 136. Preferably, personnel are identified through the creation of a personnel record within a database table or similar data structure. The personnel record contains generic identifying information regarding the person with whom the record is associated. Such generic information typically includes such things as name (first, middle, last), telephone number, fax number, address, email address and location. If the organization utilizing the present invention assigns its employees and/or contractors an identification number such as an employee number, that number typically also would be included in the generic personnel record. An exemplary personnel table is illustrated in FIG. 11 along with its relationship to other relevant data tables.

Once the generic personnel record is created identifying the appropriate personnel, the skills possessed by such personnel are specified at step 134. Typically, identifiers of various skill sets, e.g., a particular letter or number code, are specified for standardization of information. In addition to the skill identifier, other useful information may be specified with regard to each skill as desired. For instance, the number of years spent performing the skill, most recent date the skill was performed, any professional skill certifications, etc., may be indicated. Based upon this additional information, a level of proficiency may be assigned. For example, a skill level of “1” may indicate a beginner level while a skill level of “5” may indicate mastery of the skill, levels “2”, “3” and “4” designating proficiencies somewhere between beginner and master.

In the preferred embodiment, the designated skills and proficiency levels independently must be verified at step 136, prior to the personnel record being made available for viewing. Typically, the personnel manager will create the generic record, the employee/contractor will specify the skills he or she possesses, and the personnel manager will verify the skills and proficiency levels. This verification may be performed through the use of a holding table wherein the contents of the personnel record are copied into the holding table and set aside until the contents are verified. Once verified, the contents are copied back into the personnel record and made available for viewing. Alternatively, the underlying table associated with the personnel record may include a status flag or other Boolean-type column therein where a designation may be made once a record has been verified. Only verified records are available for viewing by others, thus the verification designation signals authorization for the record to be viewed. It will be understood and appreciated by those of skill in the art that any of a number of conventional methods may be used for record verification and all such methods are within the scope hereof.

Personnel records also may contain fields wherein employees/contractors may specify, at step 138, any preferences he or she may have with regard to projects. For instance, an employee/contractor may indicate that he or she would like to be placed on a project involving a skill for which only a moderate proficiency has been achieved so that he/she has the opportunity to become more proficient and learn from others of greater skill level. Alternatively, an employee/contractor may indicate that he or she would like to be placed on a project involving a skill for which he or she is already proficient either because he/she enjoys the work, or so that he/she does not lose proficiency. Any such preferences would then be visible to the personnel managers or other persons assigning personnel to projects and would facilitate employee satisfaction by providing increased opportunity for personnel to perform those skills which he/she would like to perform.

Further, personnel records also preferably contain fields wherein employee/contractors availability or status may be specified, as illustrated at step 140. This would include such information as what projects a particular employee is working on, and a time line for completion, and what projects, if any, the employee is already committed to in the pipeline (and a time line for completion). If desired, personnel vacation and training schedules and the like may also be incorporated herein so that a complete picture of availability is offered. Such information may be manually entered into the personnel record of the appropriate technical consultant. However, in the preferred embodiment, much of the scheduling information is automatically associated with the appropriate personnel records by means of cross-reference to other tables containing such information. An illustration of these tables and relationships is shown in FIG. 11. All such variations are contemplated to be within the scope hereof.

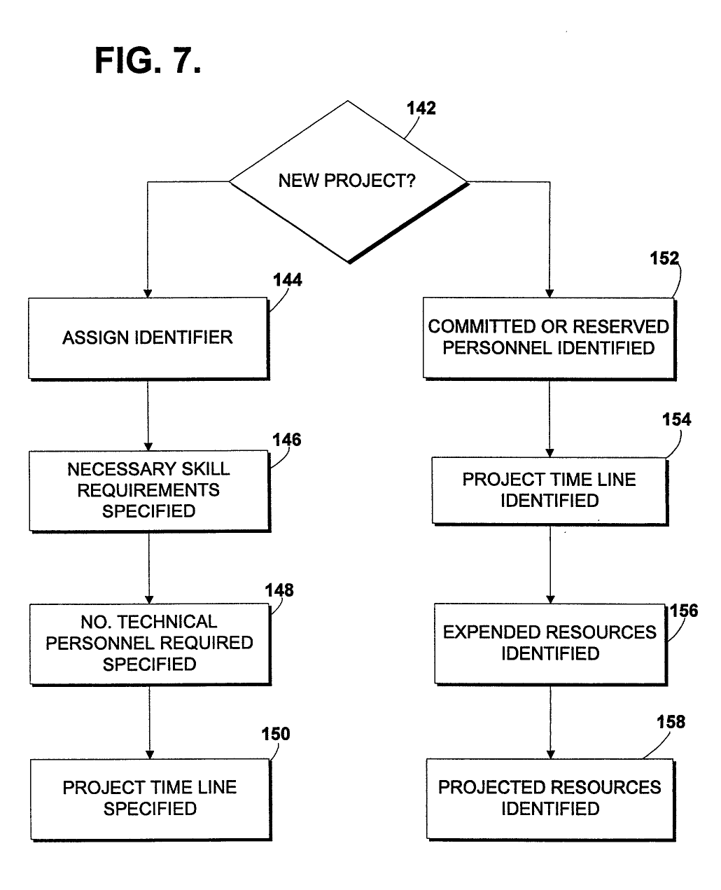

Referring now to FIG. 7, a preferred method for identifying resources is illustrated. It will be understood and appreciated that the identifying method illustrated is merely exemplary and does not limit the scope of the present invention. In general, “pipeline projects” as used herein refers to those projects for which work has yet to begin. Pipeline projects already may have personnel assigned thereto or may be awaiting such assignment.

Project identification serves at least three separate but equally important functions. First, it aids sales persons in quickly and accurately determining whether a project which he or she would like to bid on is capable of being completed utilizing the organizations' current resource pool. Thus, the sales persons will not bid on projects which cannot be timely and sufficiently staffed. Neither will the organization lose revenue through the sales persons passing on projects which could have been adequately staffed unbeknownst to the sales person. Secondly, the project identification function aids the project managers in maintaining organization. It facilitates the project managers in keeping track of all existing projects, the time spent to date on each project as well as the time budgeted to the project, and the time line for completion of each project. This leads to improved accountability of all involved in project completion. Thirdly, the project identification function aids the employees and consultants in determining what projects are in the pipeline so that he or she may bid on projects as desired. It also permits the technical personnel to see what skills are in demand so that he or she may make determinations regarding future training.

In a preferred embodiment, projects and their corresponding requirements are identified by a designated, unique project identifier. Initially, it is determined whether or not the project is a new project, i.e., one not previously entered into the database, as illustrated at step 142. If the project is a new project, a project identifier must be assigned at step 144. If, however, a project identifier already has been assigned, all additional project information may be accessed and/or entered upon identification of the project by the project identifier. A project identifier may be any of various identifiers conventionally utilized, e.g., a particular letter or number code, and may be standardized as desired. In the preferred embodiment, projects and their corresponding requirements are identified and associated with the appropriate project identifier through the creation of a project record in a projects table, such as shown in FIG. 11. The creation of a project record is much like the creation of a personnel record as previously described. The project record contains generic identifying information regarding the project with which it is associated. Such generic information typically would include such things as client (or potential client) name, telephone number, fax number, address, email address and project location. This record also typically would include the project identifier assigned to the project.

Typically, a project record initially is created by the sales person in an attempt to, on the spot, determine whether or not the organizations' resource pool is adequate to staff a particular project. Alternatively, if such inquiry either was not necessary, or not otherwise performed by the sales person, a project record may be created by the project manager assigned to the project.

Once the generic project record is created, necessary skill requirements for staffing the project are specified at step 146 and added to the record. The skill requirements include a designation of which particular skills, including proficiency levels, will be required if appropriate. Also specified is the number of technical personnel required with each skill and proficiency level, as illustrated at step 148, as well as a time table for the project, as illustrated at step 150 (including a preferred start date and projected end date). It will be understood that the start and end dates may differ among necessary personnel. Such variations may be accounted for in the software of the present invention.

Once a project record already has been created, a user may view project status and requirements. Upon identifying the project (likely with the project identifier as discussed above), the committed or reserved personnel are identified at step 152, as is the project time line at step 154, expended resources at step 156 and/or projected resources at step 158. Basically, the project identifier may be used to view where a project stands, where it is going, when it will be completed, who is committed to (or reserved for) the project, when the committed or reserved persons will roll-off the project, the resources allocated to the project (human and otherwise), and the resources expended to date. Thus, accountability is improved.

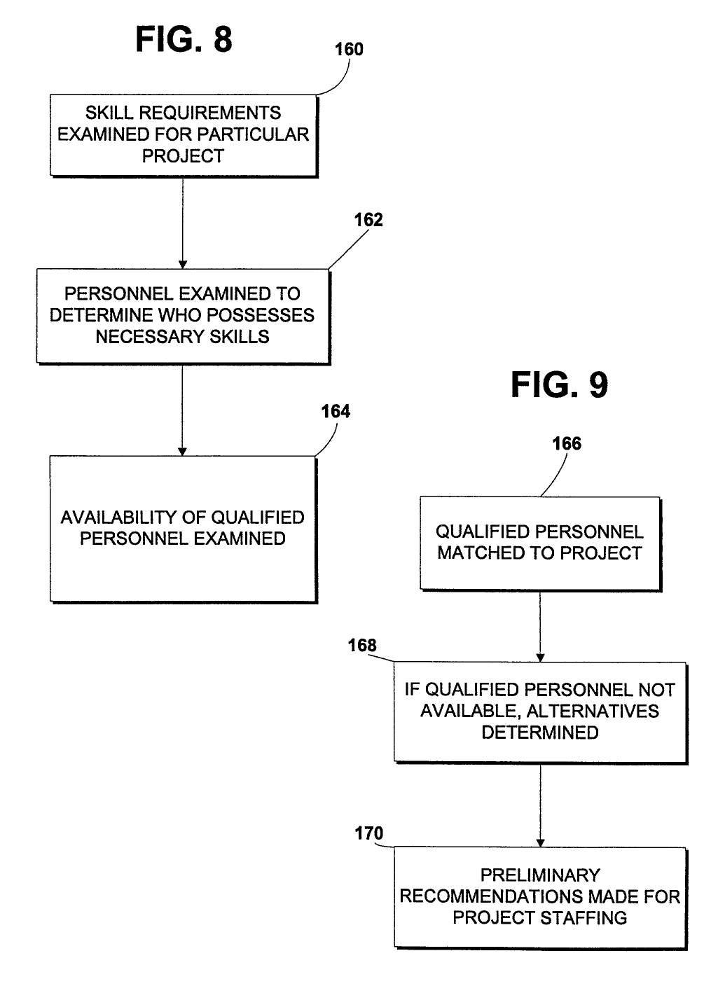

A preferred embodiment of the present invention also includes the ability to assist in staffing a project, once all necessary information regarding personnel and project requirements have been specified. With reference to FIG. 8, a preferred method for examining resource availability is illustrated. It will be understood and appreciated that the method illustrated is merely exemplary and does not limit the scope of the present invention. The present invention permits the skill requirements for a particular project to be examined at step 160 followed by an examination of all personnel records to determine which persons possess the skill sets necessary for a particular project, as illustrated at step 162. Once persons possessing the appropriate skill sets and proficiency levels have been identified, the availability of those qualified personnel is examined at step 164. The term “availability” as used herein is intended to take into account not only those projects on which a person is currently working but also those projects to which a person is committed or for which the person has been reserved. If desired, a person's availability also may take into account vacation and/or training schedules. Thus, an accurate picture of which qualified persons are available to complete which projects is provided, as well as a time line for their availability.

If, upon examination, it is determined the project cannot be staffed within the organization's resource pool, and no alternatives are available (as more fully described below), a message may be displayed indicating the lacking resource. The personnel manager then may examine the situation to determine the feasibility of filling the need in the appropriate time frame. Thus, the software of the present invention also may provide interaction with the organization's Human Resources personnel, providing the recruiting staff with visibility of staffing requirements and weaknesses.

A preferred embodiment of the present invention also includes the ability to automatically allocate resources. Once an accurate picture of which qualified persons are available to complete what projects, and when, is provided, a preliminary matching of projects and personnel is made. With reference to FIG. 9, a preferred method for preliminary matching is illustrated. It will be understood and appreciated that the matching method illustrated is merely exemplary and does not limit the scope of the present invention.

Initially, qualified personnel are matched to a project at step 166. This matching may either be performed by the software of the present invention or manually by the personnel manager, project manager, or other designated person. All such variations are contemplated to be within the scope hereof. If a qualified person is not available, alternatives are determined at step 168. For instance, imagine that a particular project requires a technical person possessing skill A at a proficiency level of 4. There is only one technical consultant who meets that requirement but she is committed on a project which required skill B at a proficiency level of 3, a skill which this person also possesses, such commitment expected to last until after the start of the project at hand. There is a second technical person who also possesses skill B at a proficiency level of 3, but no other relevant skills, who is available for the project at hand. An alternative to the situation which would facilitate staffing of both projects would be for the second technical person to replace the first technical person on the conflicting project, thus freeing the qualified person for the project at hand.

In another instance, imagine that a technical consultant having skill B at a proficiency level of 2 is necessary for a pipeline project. However, the personnel files do not have any records for personnel possessing the necessary skill and proficiency level. The personnel files do, however, contain a record of a person having skill B at a proficiency level of 4. Assuming that level 4 is a greater proficiency than the required level 2, this person may be offered as a staffing alternative for the project.

It will be understood and appreciated by those of skill in the art that any number of situations necessitating an alternative may be imagined. Means for resolving each of these situations through determination of alternatives is contemplated to be within the scope hereof.

Once personnel and projects are matched, either directly or through determination of alternatives, recommendations may be made for project staffing at step 170. Generally, these recommendations are merely preliminary and not intended to bind technical persons, personnel managers, or project managers to them. If more than one option is available, e.g., two technical consultants each possessing the necessary skill sets are available to fill one opening, both options may be presented to the user. Alternatively, the options may be given priority based upon predetermined criteria such as delineated consultant preferences, and only the highest prioritized option presented. All such variations, or combinations thereof, are contemplated to be within the scope of the present invention.

Once recommendations for project staffing have been made, the project is placed in the pipeline until the preliminary matches are confirmed or modified as more fully described below. The unassigned projects may remain in the pipeline for a predetermined period of time, if desired, to afford the technical consultants an opportunity to bid on specific projects to which they may desire to be assigned.

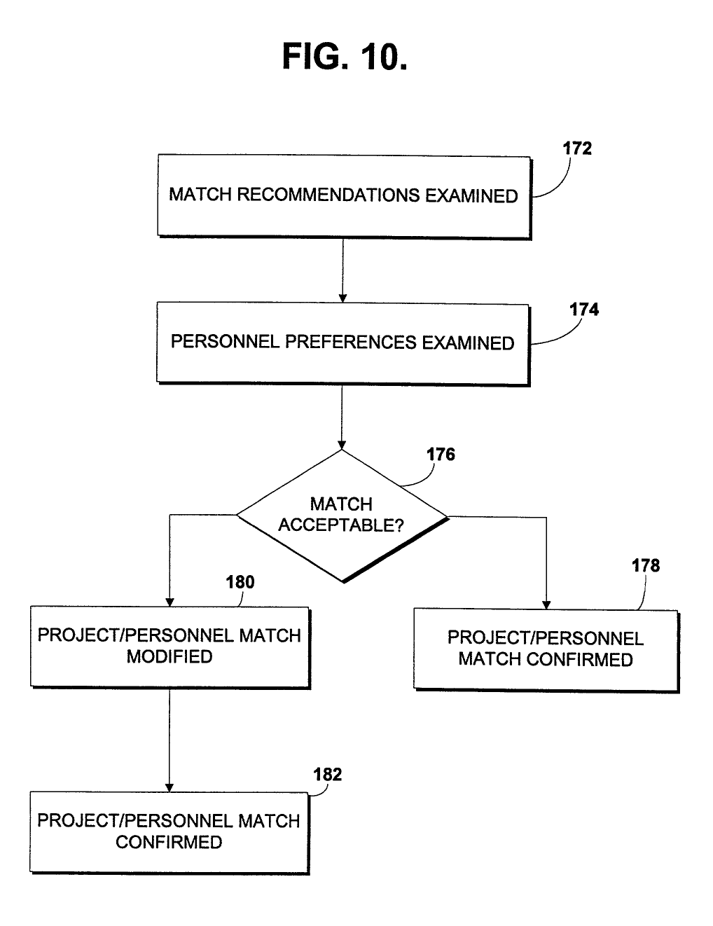

As previously discussed, recommendations are preferably only preliminary and not intended to bind technical persons or project managers. As such, before a project is signed and/or before technical personnel are committed to a project, the preliminary match independently either must be confirmed or modified. With reference to FIG. 10, a preferred method for confirming or modifying resources is defined. It will be understood and appreciated that the confirming or modifying method illustrated is merely exemplary and does not limit the scope of the present invention.

Initially, the match recommendations are examined at step 172 as are any personnel preferences at step 174. As previously discussed, technical personnel may specify any preferences he or she may have with regard to projects generally, in their associated personnel record. These preferences either may be specified at the time of creation of the personnel record or at any time thereafter, each modification to the record being independently verified prior to becoming available for viewing. In a preferred embodiment of the present invention, technical personnel also may be given an opportunity to bid on particular projects once they are in the pipeline but prior to assignment and/or confirmation. Such bidding preferences, as well as those general preferences specified in the personnel records, preferably are available simultaneously for examination by the person confirming or modifying the preliminary matching recommendations.

If the preliminary match is acceptable, as determined at step 176, the match is confirmed at step 178 and the appropriate personnel notified. Such notification may be via email or any other conventional notifying means known in the art. If the preliminary match is not acceptable, however, the match is modified at step 180 prior to its confirmation at step 182. The confirmation and modification functions typically are performed by the personnel manager. However, it is within the scope of the present invention for this function to be performed by the software itself (according to predetermined and programmed criteria) or by any desired personnel. Once all personnel have been notified, the project again is placed in the pipeline until such time as work begins.

A preferred embodiment of the present invention also includes the ability to provide varying levels of individual and group access to available information. For instance, technical consultants may be able to view information associated with particular project records but not be permitted to modify such information. The project managers, however, may be able to both view and modify project records. Further, technical personnel may be able to both view and modify their own personnel records but not have access to the records of other personnel. Any and all access variations are contemplated to be within the scope of the present invention and the following is merely exemplary and not intended by way of limitation.

In a preferred embodiment, when the personnel manager creates a personnel record for a particular technical consultant, he or she may assign a given level of security. Levels of security preferably are standardized with a particular number or letter code offering a predefined scope of access to information available. For instance, a security level of “1” may be provided to technical consultants and permit the consultant associated therewith to view and modify their own personnel record, view the current schedule and pipeline projects, and bid on particular projects. Likewise, a security level of “2” may be provided to sales personnel and permit the sales person associated therewith to create project records, modify only those project records which the particular sales person created, and view all personnel records. It will be understood and appreciated that alternate means of providing security are known to those skilled in the art and such variations are contemplated to be within the scope of the present invention.

The present invention is an application which is designed to support internal management of resources within an organization. For example, in one embodiment, the present invention is an application which provides a mechanism for sales people to be able to determine what people with what skills are available, for what specified time frames, and project (by entering pipeline information) what skills will be needed by the projects they are selling. In addition, project managers are able to monitor technical personnel assigned to projects, and identify when these personnel are projected to be finished with the work on a given project. Personnel managers are able to view and verify the skills which technical personnel report, assign technical personnel to projects, and keep track of which projects each technical consultant has worked on over a given period of time.

Additional key features of the present invention are those associated with the consultants. Each technical consultants is able to view current projects and projected (pipeline) projects to see what skills are and will be in demand and on what time line, to bid on work with specific projects, view when the project manager expects them to complete their current project, and check/update their skills list.

This product will give its users a significant operational advantage in the area of resourcing and managing those human resources associated with service organizations. It will also assist organizations in organizing their resources and in keeping the skill-sets of the technical personnel aligned with the market demands, through visibility of those demands.

In summary, the present invention is directed to a system and method for organizing projects and project resources in a computer system. The present invention has been described in relation to particular embodiments which are intended in all respects to be illustrative rather than restrictive. Alternative embodiments will become apparent to those skilled in the art to which the present invention pertains without departing from its scope.

From the foregoing, it will be seen that this invention is one well adapted to attain all the ends and objects herein above set forth together with other advantages which are obvious and which are inherent to the system and method. It will be understood that certain features and subcombinations are of utility and may be employed without reference to other features and subcombinations. This is contemplated by and is within the scope of the claims.

Having thus described the invention, what is claimed is:

1. A method in a computing environment for managing resources, the method comprising:
providing resources, said resources including one or more of personnel, skills, and skill proficiency levels;
providing requirements associated with a project, said requirements including one or more of required skills, required skill proficiency levels, required number of personnel, and required time table;
determining if said resources fulfill said requirements; and
if said resources fulfill said requirements, preliminarily matching said resources with said project.

2. The method as recited in claim 1, further comprising:
confirming said preliminary matching; and
notifying personnel matched.

3. The method as recited in claim 1, further comprising:
modifying said preliminary matching to create a modified match; and
notifying personnel matched in said modified match.

4. The method as recited in claim 1, wherein said resources further include personnel availability.

5. The method as recited in claim 1, wherein said resources further include personnel preferences.

6. The method as recited in claim 1, further comprising defining said resources, wherein defining resources includes:
identifying personnel;
specifying skills possessed by identified personnel; and
verifying skills specified.

7. The method as recited in claim 6, wherein defining resources further includes assigning each said verified skill a standardized skill proficiency level.

8. The method as recited in claim 1, wherein if said resources do not fulfill said requirements, an alternative preliminary matching is provided.

9. The method as recited in claim 8, wherein said alternative preliminary matching includes resources which exceed said requirements.

10. The method as recited in claim 9, further comprising:
confirming said alternative preliminary matching; and
notifying personnel matched by said alternative preliminary matching.

11. The method as recited in claim 9, further comprising:
modifying said alternative preliminary matching to create a modified match; and
notifying personnel matched in said modified match.

12. A computer readable medium having computer executable instructions for performing the steps recited in claim 1.

13. A computer system having a processor, a memory and an operating environment, the computer system operable to perform the steps recited in claim 1.

14. A method in a computing environment for managing resources, the method comprising:
accessing a definition of resources, said resources including one or more of personnel, skills, and skill proficiency levels;
accessing a definition of requirements associated with a project, said requirements including one or more of required skills, required skill proficiency levels, required number of personnel, and required time table;
preliminarily matching said resources with said project; and
notifying personnel matched.

15. The method as recited in claim 14, further comprising determining if said resources fulfill said requirements prior to preliminarily matching said resources with said project.

16. The method as recited in claim 15, further comprising, prior to notifying personnel matched, confirming said preliminary matching.

17. The method as recited in claim 15, further comprising, prior to notifying personnel matched, modifying said preliminary matching to create a modified match, wherein said personnel matched are those matched in said modified match.

18. The method as recited in claim 14, wherein said resources further include personnel availability.

19. The method as recited in claim 14, wherein said resources further include personnel preferences.

20. The method as recited in claim 15, wherein said step of preliminarily matching said resources with said project occurs only if it is determined that said resources fulfill said project requirements.

21. The method as recited in claim 15, wherein if it is determined that said resources do not fulfill said project requirements, an alternative preliminary matching is provided.

22. The method as recited in claim 21, wherein said alternative preliminary matching includes resources which exceed said requirements.

23. The method as recited in claim 22, further comprising, prior to notifying personnel matched, confirming said alternative preliminary matching.

24. The method as recited in claim 22, further comprising, prior to notifying personnel matched, modifying said preliminary matching to create a modified match, wherein said personnel notified are those matched in said modified match.

25. A computer readable medium having computer executable instructions for performing the steps recited in claim 14.

26. A computer system having a processor, a memory and an operating environment, the computer system operable to perform the steps recited in claim 14.

27. A method in a computing environment for managing resources, the method comprising:
accessing information indicative of resources, said resources including one or more of personnel, skills, and skill proficiency levels;
accessing information indicative of projects and requirements associated therewith, said requirements including one or more of required skills, required skill proficiency levels, required number of personnel and required time table; and
utilizing said information indicative of resources, projects and project requirements to ascertain whether said resources fulfill said requirements.

28. The method as recited in claim 27, wherein said accessing of information indicative of personnel, projects and project requirements is accomplished remotely.

29. The method as recited in claim 27, wherein said resources further include personnel availability.

30. The method as recited in claim 27, wherein said resources further include personnel preferences.

31. A computer readable medium having computer executable instructions for performing the steps recited in claim 27.

32. A computer system having a processor, a memory and an operating environment, the computer system operable to perform the steps recited in claim 27.

33. A method in a computing environment for resource planning and scheduling, the method comprising:
providing a forum wherein personnel indicate preferences to use particular skills; and
providing a schedule of personnel for a project, wherein said preference is utilized in allocating resources to said project and in preparing said schedule.

34. A system for use in a computing environment for managing resources, said system comprising:
a data repository including
information indicative of resources, said resources including one or more of personnel, skills, and skill proficiency levels;
information indicative of projects and project requirements, said project requirements including one or more of required skills, required skill proficiency levels, required number of personnel, and required time table; and
information indicative of cross-references between said resource specifications and said project requirements; and
a data processing system adapted to perform multiple functions, said functions including one or more of matching personnel to projects, tracking personnel availability, and allocating personnel to projects.

35. The system of claim 34, wherein said resources further include personnel availability.

36. The system of claim 34, wherein said resources further include personnel preferences.

37. A system for use in a computing environment for automated matching of resources to a project, the system comprising:
at least one data stores which includes information indicative of one or more of personnel, personnel skills, project skill requirements, and personnel assignments to projects; and
at least one program adapted to allocate personnel to projects utilizing said data store information.
